(19) United States
(12) Patent Application Publication
(10) Pub. No.: US 2014/0372147 A1
(43) Pub. Date: Dec. 18, 2014

(54) SYSTEMS, METHODS, AND ENVIRONMENT FOR IDENTIFICATION AND PROCESSING OF MEDICAL EVENTS

(71) Applicant: NaviNet, Inc., Boston, MA (US)

(72) Inventor: Jason White, Boston, MA (US)

(21) Appl. No.: 14/301,532

(22) Filed: Jun. 11, 2014

Related U.S. Application Data
(60) Provisional application No. 61/834,764, filed on Jun. 13, 2013.

(51) Int. Cl. G06F 19/00; G06F 17/30

(52) U.S. Cl. CPC G06F 19/322; G06F 17/30477
USPC 705/3

(57) ABSTRACT

Described herein is a medical network intelligence environment that includes a central event processing system for receiving, processing, and routing messages triggered by real-time medical events. The central event processing system, for example, may identify patient information associated with a medical event and match the patient information to one or more of a health plan, a clinical location, a health-related study, or a utilization management system. Upon matching the medical event with the interested parties, the central event processing system may forward at least a portion of the information regarding the medical event to one or more interested parties within a short period of time of the triggering event (e.g., in near real-time). For example, based upon rules associated with each interested party, the central event processing system may forward information and/or issue an alert or notification to an interested party to make the interested party aware of the medical event.

### RELATED APPLICATIONS

The present application claims priority to and the benefit of U.S. Provisional Patent Application Ser. No. 61/834,764, filed Jun. 13, 2013, titled “SYSTEMS, METHODS, AND ENVIRONMENT FOR IDENTIFICATION AND PROCESSING OF MEDICAL EVENTS,” the content of which is incorporated herein by reference in its entirety.

### BACKGROUND

Millions of healthcare encounters occur within the United States every day. Thus, there are millions of digitized, real-time healthcare transactions taking place on the world-wide-web and computer networks, providing terabytes' worth of ‘big-data’ corresponding to real-time events. There have been advances made in leveraging this big-data, at rest. For example, medical insurance claims data has been used in predictive modeling tools to identify high-risk patients and provide them with proactive care. However, the potential of real-time big-data events has remained largely untapped.

### SUMMARY

It is an object of systems and methods described herein to harness the big-data created from healthcare encounters in real-time to promote event-driven collaboration in healthcare, improve care-related outcomes, and reduce costs across the population.

To illustrate this concept, consider the situation in which a patient visits a health care provider and his/her health care plan eligibility is verified. Verification of health care eligibility and benefits is a standard transaction that is generally processed in real-time by an administrator in the health care provider office upon presentation of the patient at the office, in order to confirm whether the member/patient has appropriate health plan benefits and coverage for the visit. This transaction typically signifies the beginning of a patient encounter in a provider office. Currently, such information-rich events end and are forgotten once verification is complete; hence, valuable contextual information about the clinical encounter is not utilized.

Events such as these, when tapped and distributed on an intelligent network, allow numerous 3^{rd} party stakeholders /technology partners to provide real-time alerts and clinical content that significantly enhances a clinical encounter. For example, by using the real-time information generated from such transactions, a health plan can send care considerations that remind the provider that a patient is due for a particular blood test, or an analytics technology partner may provide an alert to the health care provider regarding patient risk profile. Similarly, a specialist referral notification to the health plan and distribution of that event on an intelligent network may provide the opportunity for a technology provider to suggest high-quality/low cost specialists based on specified diagnosis and patient geography, for example.

In another illustration of this concept, the analytics capabilities of Health Information Exchanges (HIEs) are used to derive meaningful insight about patterns of activity on the network at multiple levels—e.g., the individual patient, health care provider, provider group, and insurer—and to share this knowledge of processed events in real-time (this term, as used herein, is inclusive of near real-time) with network subscribers. For example, a triggering event could be receipt of a hospital Admission, Discharge, Transfer (ADT) alert for a patient on the network, and/or display of the event to a user on a network portal. One or more members of the patient's primary care team could be notified immediately upon occurrence of this trigger event, facilitating a more effective transition management for the patient from an acute care facility to a step-down facility or recovery with primary care physician guidance.

Furthermore, in certain embodiments, a multi-payer network portal is utilized. The multi-payer portal allows users to access information for multiple health plans in a single portal with similar look-and-feel across health plans, and with a single login, as opposed to multiple portal logins for each health plan. The user experience is thereby improved, and utilization is facilitated, requiring fewer phone calls to health plan administrators.

Thus, described herein is a medical network intelligence environment that includes a central event processing system for receiving, processing, and routing messages triggered by real-time medical events, such as, in some examples, eligibility of medical benefits requests (E&Bs), admission discharge transfer messages (ADTs), imaging exchange messages, and medical billing system exchange messages. The central event processing system, for example, may identify patient information associated with a medical event and match the patient information to one or more of a health plan (e.g., associated with a particular medical insurance provider), a clinical location (e.g., primary care physician), a health-related study (e.g., government research, clinical research, etc.), or a utilization management system (e.g., military veteran benefits system, disability insurance claim, etc.).

Upon matching the medical event with the interested parties, in some implementations, the central event processing system may forward at least a portion of the information regarding the medical event to one or more interested parties. For example, based upon rules associated with each interested party, the central event processing system may forward information and/or issue an alert or notification to an interested party to make the interested party aware of the medical event. For example, upon recognizing a E&B message related to a patient admission into an emergency room, the central event processing system may issue an alert to a primary care physician or log the event with a medical study in which the patient has been participating.

In some implementations, upon matching the medical event with one or more interested parties, the central event processing system forwards patient information to the originator of the medical event. For example, upon matching a patient identifier with a health plan, the central event processing system may support the forwarding of at least a portion of the patients electronic medical record (EMR) to the originator of the medical event (e.g., ambulance check-in), thus providing real-time patient information to aid in assessing and responding to a potential life threatening event.

In one aspect, the invention relates to a method comprising the steps of: receiving, from an external computing device, via a network, event data regarding a medical event, wherein the medical event is associated with a patient, and the event data is received within a time period corresponding to substantially real time in relation to occurrence of the medical event; mapping, by a processor of a computing device, the event data to a particular event type of a plurality of event types; applying, by the processor, one or more filters to the event data based at least in part upon the particular event type to determine at least a first matching filter of the one or more filters, wherein each filter of the one or more filters corresponds to a respective handling activity; routing, by the processor, at least a portion of the event data according to the handling activity of the first matching filter; and archiving, by the processor, audit data corresponding to the handling activity.

In some embodiments, the method includes, prior to mapping the event data to the particular type, determining whether the patient associated with the medical event has agreed to participation. In some embodiments, applying the one or more filters comprises applying, based upon the patient having not agreed to participation, one or more filters configured to capture information regarding anonymous medical events. In some embodiments, the method includes, prior to applying the one or more filters, determining, by the processor, no duplicate event exists for the medical event. In some embodiments, determining no duplicate event exists comprises determining no prior event of the particular event type occurred in relation to the patient, within a predetermined period of time.

In some embodiments, mapping the event data further comprises reformatting the event data to a standard canonical data format.

In some embodiments, applying the one or more filters comprises determining a third party entity associated with the patient. In some embodiments, the third party entity comprises at least one of an employer, a health plan provider, a clinical facility, and an integrated delivery system.

In some embodiments, receiving the event data comprises receiving, from a third party computing system, a request for verification of eligibility of medical benefits. In some embodiments, the external computing device comprises a biometric device of the patient. In some embodiments, the time period comprises twenty-four hours. In some embodiments, the event type comprises one or more of emergency room registration and emergency care facility registration. In some embodiments, the handling activity comprises issuing an alert to at least one of a medical facility and a clinician associated with the patient.

In another aspect, the invention relates to a system comprising: a processor; and a memory having instructions stored thereon, wherein the instructions, when executed by the processor, cause the processor to: receive event data regarding a medical event, wherein the medical event is associated with a patient; determine a follow-on event corresponding to the medical event, wherein the follow-on event is associated with a time period; after the time period has expired, determine no historic medical events associated with the patient match the follow-on event; trigger a non-event, wherein the non-event relates to evident failure of the patient to perform an activity corresponding to the follow-on event within the time period; apply one or more filters to the non-event based at least in part upon an event type of the follow-on event to determine at least a first matching filter of the one or more filters, wherein each filter of the one or more filters corresponds to a respective handling activity; and route data corresponding to the non-event according to the handling activity of the first matching filter.

In some embodiments, the follow-on event comprises a medical facility visit and the handling activity comprises issuing an alert to the medical facility. In some embodiments, the event data is imported from one of a health information exchange, a customer relationship management system, and a care management system. In some embodiments, the instructions cause the processor to, after routing the data, archive audit data corresponding to the handling activity.

In another aspect, the invention relates to a non-transitory computer readable medium having instructions stored thereon, wherein the instructions, when executed by a processor, cause the processor to: receive, from an external computing device, via a network, event data regarding a medical event, wherein the medical event is associated with a patient, and the event data is received within a time period corresponding to substantially real time in relation to occurrence of the medical event; apply one or more filters to the event data based at least in part upon a particular event type of the medical event to determine at least a first matching filter of the one or more filters, wherein each filter of the one or more filters corresponds to a respective handling activity; perform the handling activity of the first matching filter, wherein performing the handling activity comprises providing information regarding at least one of the medical event and the patient to a third party computing system within a second time period corresponding to substantially real time in relation to the occurrence of the medical event; and archive audit data corresponding to the handling activity.

In some embodiments, the third party computing system comprises the external computing device. In some embodiments, the second time period comprises less than five minutes.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of a medical network intelligence environment for identification and processing of medical events;

FIG. 2 is a flow diagram of an example processing flow of an event within a medical network intelligence environment;

FIG. 3 is a flow chart of an example method for handling incoming medical events;

FIG. 4 is a flow chart of an example method for handling medical non-events;

FIGS. 5A through 5C are screen shots of example user interfaces for receiving information derived from medical event processing;

FIG. 6 is a block diagram of an example network environment for identification and processing of medical events; and

FIG. 7 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, a medical network intelligence environment includes a central event processing system for receiving, processing, and routing messages regarding real time medical events such as eligibility of medical benefits requests (E&Bs), admission discharge transfer messages (ADTs), imaging exchange messages, and medical billing system exchange messages. The central event processing system, for example, may identify patient information associated with a medical event and match the patient information to a health plan (e.g., associated with a particular medical insurance provider). In other examples, the patient information may be associated with a clinical location (e.g., primary care physician), a health-related study (e.g., government research, clinical research, etc.), or a utilization management system (e.g., military veteran benefits system, disability insurance claim, etc.). The central event processing system, in some implementations, matches the patient information with two or more interested parties (e.g., both a health plan and a primary care provider, etc.).

Upon matching the medical event with one or more interested parties, the central event processing system may forward at least a portion of the information regarding the medical event to one or more interested parties. For example, based upon rules associated with each interested party, the central event processing system may forward information and/or issue an alert to an interested party to make the interested party aware of the medical event. For example, upon recognizing an E&B message related to a patient admission into an emergency room, the central event processing system may issue an alert to a primary care physician or log the event with a medical study in which the patient has been participating.

In some implementations, upon matching the medical event with one or more interested parties, the central event processing system forwards patient information to the originator of the medical event. For example, upon matching a patient identifier with a health plan, the central event processing system may support the forwarding of at least a portion of the patient's electronic medical record (EMR) to the originator of the medical event (e.g., ambulance check-in), thus providing real-time patient information to aid in assessing and responding to a potential life threatening event.

In some implementations, the central event processing system reformats at least a portion of the medical events into a standard format and stores the medical events within a database. For example, stored medical events may be processed on a set schedule (e.g., hourly, twice daily, daily, weekly, etc.) to derive information of interest to one or more third parties, but not of critical (e.g., real-time) interest to the third party. For example, the coordinator of a health study may wish to review activity related to patients participating in the study on a daily or weekly basis to identify medical activity such as hospital visits, clinical visits, and prescription pick-ups.

In some implementations, in addition to processing real time medical events, the central event processing system receives historic medical event data, for example from a health information exchange (HIE), customer relationship management system (CRM), or a care management system. For example, by collecting medical event data processed by other (partner) systems, the central event processing system may be enabled to derived greater value-added metrics associated with individual patients.

In some implementations, the central event processing system predicts one or more future events based upon processed medical events. For example, based upon a doctor's visit in which a medication was prescribed, the central event processing system may predict fulfillment of the medical prescription by a pharmacy within a certain period of time (e.g., thirty-six hours, three days, etc.). The central event processing system, in some implementations, schedules identification of a “non-event” in response to failure of the central event processing system to identify the predicted future event within the set period of time. For example, if, after forty-eight hours, the central event processing system has not identified fulfillment of the prescribed medication, the central event processing system may trigger a “non-event” related to the prescription, such as alerting the primary care physician of failure of the patient to fulfill the prescription.

In some implementations, the central event processing system includes a user interface for customizing rules related to events. Each rule, for example, may correspond to at least one event type and at least one action. In a particular example, a rule may be designed to identify any ambulance, hospital, or urgent care event corresponding to a patient of a particular smoking cessation study, and to forward information related to the event to a coordinator of the smoking cessation study.

Additionally, in some implementations, the central event processing system includes a user portal for reviewing information related to events. The user portal, for example, may provide messages, alerts, and drill-down information corresponding to a set of patients associated with a third party entity having access to the user portal. For example, a clinician's office may coordinate patient information using a portal provided in part by the central event processing system.

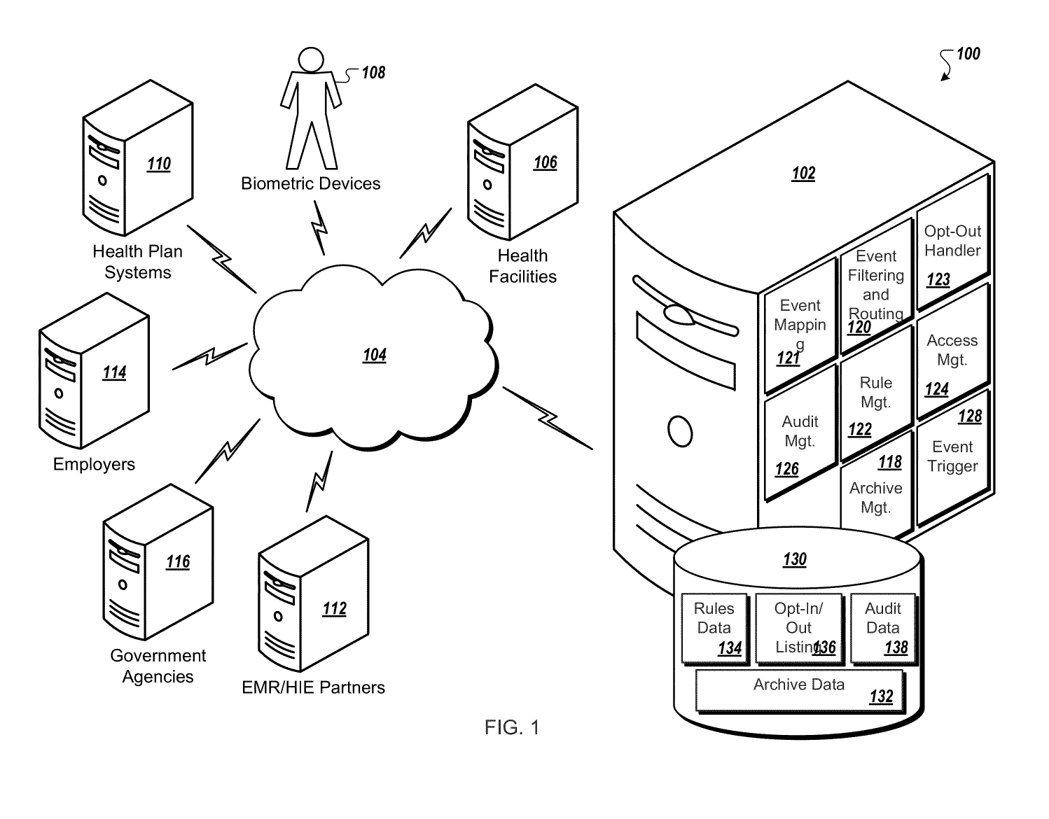

The central event processing system, and the medical intelligence network environment connected thereto, are described in further detail below in relation to the following figures. Turning to FIG. 1, a block diagram illustrates a medical network intelligence environment 100 for identification and processing of medical events. Medical event information is provided to a central processing system 102 via a network 104 from a number of sources such as, in some examples, one or more health facilities 106 (e.g., hospitals, clinician offices, imaging offices, dental offices, optometrist offices, alternative medicine provider offices, or other systems emitting admission discharge transfer communications such as ambulance services), one or more biometric devices 108 (e.g., devices implanted in, worn by, or otherwise used by a patient such as an artificial cardiac pacemaker, medical scale, or automated insulin pump), one or more health plan systems 110 (e.g., health insurance providers, dental insurance providers, vision insurance providers, care management providers, etc.), and/or one or more electronic medical record (EMR), personal health record (PMR) and/or health information exchange (HIE) partners 112 of the central processing system 102. In other examples (not illustrated), the central processing system 102 may be provided with event data by one or more analytics engines, one or more medical referrals systems, one or more authorization or utilization management systems (e.g., in relation to insurance claim processing or law suit award processing, etc.), one or more laboratory exchanges, one or more imaging exchanges or drop boxes, one or more customer relationship management systems, one or more medical billing systems, one or more wellness-related facilities or programs (e.g., fitness clubs, weight loss organizations, yoga centers, martial arts training facilities, swim clubs, tennis/racquet ball clubs, golf clubs, etc.), and/or one or more travel-related systems (e.g., travel insurance programs, etc.). In some implementations, the additional sources identified above may provide unique identification information corresponding to user identification maintained by one or more of the primary (e.g., illustrated) sources, such as the health plan systems 110, employers 114, or government agencies 116.

Similarly, upon processing the medical events, the central processing system 102 may provide information to one or more external sources such as the health facilities 106, health plan systems 110, EMR/HIE partners 112, one or more employers 114 (e.g., as part of an employee wellness program, etc.) and/or one or more government agents 116 (e.g., research agencies, policy groups, immigration systems, and/or immunization registries, etc.). The information, in some implementations, is provided via an electronic medical record system, such that real time information may be presented while entering patient information into the system of one of the third party correspondents. Furthermore, information collected by the central processing system 102 may be shared with a number of third party systems for analytics and records purposes such as, in some examples, analytics engines, accountable care organizations, patient-centered medical homes, risk-bearing entities, and EMR/PHR/HIE partners 112.

Upon receipt of medical event information, in some implementations, an event mapping module 121 may map the event information to a standard format suitable for processing. The event mapping module 121, for example, may map particular event types to more general event categories. In another example, the event mapping module 121 may reformat the medical event information to a standard canonical data format. The processing performed by the event mapping module 121, in some implementations, may depend upon analysis by an opt-out handling module 123. For example, the opt-out handling module 123 may determine whether a patient associated with the medical event has opted out (or, alternatively, opted in) for individualized processing by the central processing system 102, as identified within an opt-in (or opt-out) listing 136 of a data store 130. If, for example, the patient has not agreed to partake in processing by the central processing system 102, the event mapping module 121 may make the medical event information anonymous prior to providing the information to an archive management module 118 for archival and statistical recording purposes. For example, the archive management module 118 may store anonymous medical event information within archive data 132 of the data store 130 (e.g., one or more memory devices attached to and/or in communication with the central processing system 102). The archive data 132, in some implementations, represents a temporary data cache, wherein a separate long term storage facility may be used for management of older archived data (e.g., more than one week, one month, etc.). Additionally, the event mapping module 121 may process medical event data according to one or more privacy filters (e.g., according to the Health Insurance Portability and Accountability Act (HIPAA) or other government body provided protection) or third party partner filters (e.g., health plan contract-related filters, medical research agreement-related filters, etc.) to guide further processing of the record and to protect sensitive patient information.

In some implementations, the mapped event data, if not blocked due to patient opt-out or other privacy management, is stored by the archive management module 126 as archive data 132 (e.g., without being made anonymous). In this way, data associated with a particular patient's events may be archived for future use. In some implementations, the archive management module 118 shares archived data (e.g., on a periodic basis or upon a request basis) with one or more third party partners, such as one or more of the EMR/HIE partners 112.

In some implementations, once the event data has been mapped and determined to be associated with a patient (and program) identified as having opted in for event processing, the event data is provided to an event filtering and routing module 120 for filtering by predefined rules. In some implementations, the rules (e.g., rules data 134 stored within the data store 130) designate actions to apply to events satisfying one or more filter criteria, such as an event type criteria (e.g., prescription fulfillment, emergency room admission, imaging order availability, etc.), a health plan criteria (e.g., members of a particular health plan or a particular service level of a particular health plan, etc.), an employer criteria (e.g., employees of a particular entity), a research study criteria (e.g., participant of a particular study), a primary care facility criteria (e.g., patients of a particular office), and/or a critical care facility criteria (e.g., events generated by an ambulance service, hospital emergency room, or other critical care facility). The actions, in some implementations, may include the forwarding of information and/or issuance of alert notifications to designated accounts (e.g., network portal accounts third party systems have established with the central processing system 102) or via designated communication channels. The communication channels, in some examples, may include short message system (SMS) numbers, email addresses, machine-to-machine communication channels (e.g., secure Internet connection channels between the central processing system 102 and a third party system), mobile device applications configured to communicate with the central processing system, and/or facsimile numbers.

In some implementations, the event filtering and routing module 120 executes code (e.g., java script or other suitable code) to determine the rules by which filtering is performed. For example, the code may call an analytics engine with one or more data sources for the purpose of evaluating a set of input conditions relating to a particular event. Once the event data has been mapped and determined to be associated with a patient (and program) identified as having opted in for event processing, execution of the code is triggered, the rules are determined, and event filtering in accordance with the rules is performed.

Rules may be established based upon patient management needs of particular third party members of the medical network intelligence environment 100, such as the health facilities 106, health plan systems 110, employers 114, and government agencies 116. In some implementations, based upon rules associated with each interested party, the central processing system 102 may forward information and/or issue an alert to an interested party to make the interested party aware of the medical event. For example, upon recognizing a E&B message related to a patient admission into an emergency room, the central processing system 102 may issue an alert to a primary care physician (e.g., one of the health facilities 106) or log the event with a medical study (e.g., via one of the government agencies 116, one of the health plan systems 110, or one of the health facilities 106) in which the patient has been participating.

In some implementations, one or more rules involve accessing information regarding a patient indicated by the event and responding to the originator of the event. For example, upon matching the medical event with one or more interested parties, the central processing system 102 may forward patient information to the originator of the medical event. In a particular example, upon matching a patient identifier with a health plan, the central processing system 102 may support the forwarding of at least a portion of the patient's electronic medical record (EMR) to the originator of the medical event (e.g., ambulance check-in), thus providing real-time patient information to aid in assessing and responding to a potential life threatening event.

In some implementations, rule data 134 is established via a rule management module 122. For example, the rule management module 122 may provide a user interface and one or more tools for establishing rules specific to needs of different customer or customer groups. In some implementations, access to the rule management module 122 may be restricted, for example by an access management module 124.

In some implementations, one or more rules may have been established by a third party system via the rule management module 122. The central processing system 102 may include a software application, web portal, or other user interface for customized rule establishment by third party partners. In some implementations, access to the rule management module 122 is governed by the access management module 124. For example, the access management module 124 may authenticate user access and restrict a user's rule establishment to data available to the particular third party. For example, a member of Health Plan ABC may be restricted from establishing a rule related to patients of Health Plan XYZ.

Returning to the event filtering and routing module 120, once an event has been routed according to pertinent rule data 134, information related to the routing of the event (e.g., forwarding of information or issuance of a notification, etc.) may be archived by an audit management module 126 as audit data 138 in the data store 130. The audit data 138, for example, may contain a series of records identifying a timestamp, a medical event (e.g., full event data, partial event data, or a link cross-referenced into the archive data 132), a rule (e.g., rule name, full rule data, or link cross-referenced into the rules data 134), and/or a recipient (e.g., communication channel or end user/entity associated with the handling of the event).

In some implementations, one or more rules involve the triggering of a future medical event. For example, based upon one or more rules established within the rules data 134, an event trigger module 128 may generate a future event watch anticipating a particular follow-on medical event to occur within a predetermined period of time. The future event watch may be an internal (to the central processing system 102) custom rule or periodic query of the archive data 132 which reviews incoming medical events for a match to the anticipated future event. In a particular example, the rules data 134 may include a rule configured to identify a birth of a newborn and to generate, via the event trigger module 128, one or more anticipated future event watches corresponding to the recommended periodic well-baby visits. Upon failure to identify a visit of the newborn to the pediatrician within the predetermined time frame (such as one month plus a certain number of excess days to allow for scheduling conflicts and other delays), for example, the event trigger module 128 may trigger an internal medical event (e.g., “missed event” or “non-event”) which, upon filtering by the event filtering and routing module 120 according to rules data 134, may issue a reminder to the pediatrician to follow up with the parents of the newborn.

The architecture of the central processing system 102 and the third party systems 106, 108, 110, 112, 114, and 116 are presented for illustrative purposes only. Other architectures and mixtures of systems within the medical network intelligence environment 100 are possible. The central processing system 102, for example, may include a number of inter-related computing devices (e.g., servers, systems, storage facilities, etc.) working in coordination to perform the features described above in relation to the various modules. Although illustrated as communicating within the single network 104, in some implementations, communications may be issued to and from the central processing system 102 over a variety of networks, such as interactive voice response (IVR) communications or short message service (SMS) communications via a telephony and/or cellular network. Other differences are possible. Additional variations and capabilities are described below.

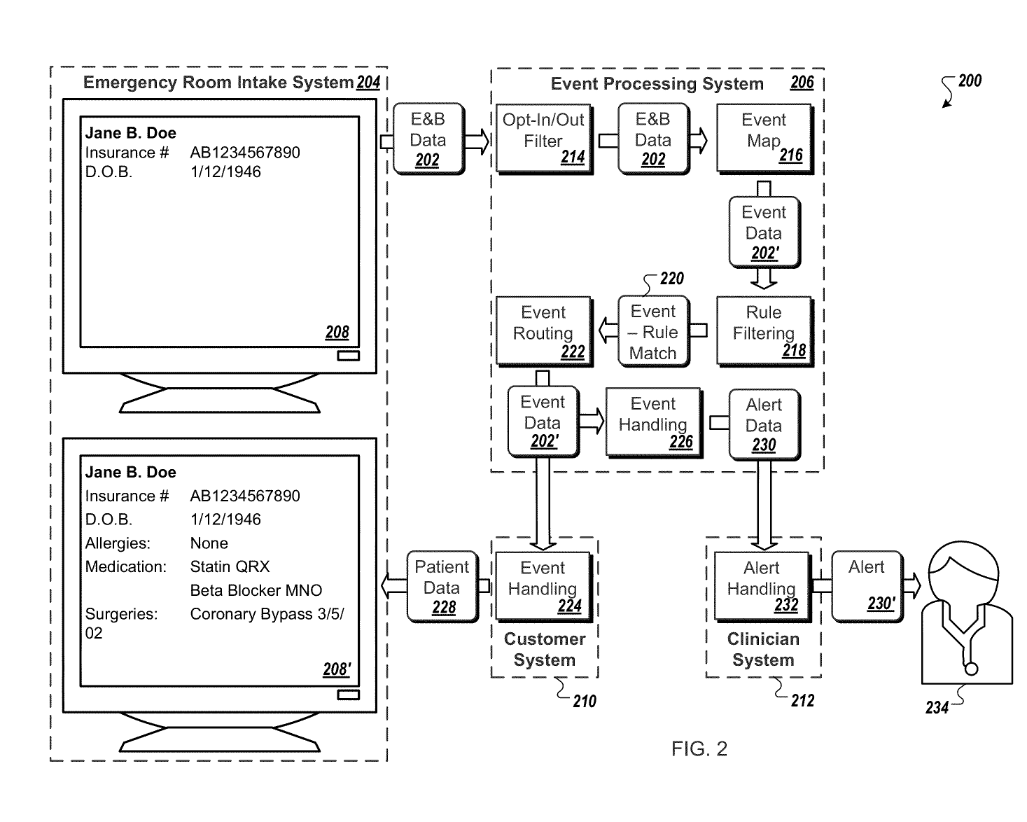

Turning to FIG. 2, a flow diagram illustrates an example processing flow 200 of a medical event 202 within a medical network intelligence environment including an event processing system 206 in communication with an emergency room intake system 204, a customer system 210, and a clinician system 212. The medical event 202 includes an eligibility of medical benefits request (E&B) related to patient Jane B. Doe (insurance number AB1234567890, date of birth Jan. 12, 1946), as entered into a user interface 208 of the emergency room intake system 204. The medical event 202 (e.g., E&B data) is provided from the emergency room intake system 204 to the event processing system 206. In some examples, the emergency room intake system 204 may supply E&B data (and, possibly, other medical event data) directly to the event processing system 206, for example via the Internet. In other implementations (not illustrated), the event data 202 may be passed to an intermediate processing system (e.g., electronic medical record management system, authorization system, utilization management system, health information exchange, or admission discharge transfer system) prior to being forwarded to the event processing system 206.

Within the event processing system 206, in some implementations, the medical event 202 is processed by an opt-in (or opt-out) filter 214. For example, a patient identifier may be cross-referenced with a collection of patients identified as having opted in (or, alternatively, having opted out) of the advanced processing features provided by the event processing system 206. The opt-out handler module 123, as described in relation to FIG. 1, for example, may verify whether the patient identifier matches a record within the opt-in/opt-out listing 136.

Upon determining that the patient has agreed to allow medical event processing, in some implementations, the event 202 is processed by an event mapping feature 216. For example, as described in relation to the event mapping module 121 of FIG. 1, the event mapping feature 216 may be an event type of the event 202 to a general event category and/or reformat the information of the medical event 202 to a standard canonical data format. In some implementations, the event mapping feature 216 outputs mapped event data 202′ to a rule filtering feature 218.

In some implementations, the rule filtering feature 218, similar to a portion of the functionality of the event filtering and routing module 120 described in relation to FIG. 1, filters the mapped event data 202′ by one or more rules to determine one or more matching rules (e.g., rules identifying activities that apply to the event data 202′). As illustrated, the rule filtering feature 218 determines an event-rule match 220 with the mapped event data 202′. The event-rule match 220, for example, may identify one or more actions to apply in relation to the mapped event data 202′. In some implementations, the rule filtering feature 218 supplies the event-rule match 220 to an event routing feature 222.

The event routing feature 222, similar to additional functionality provided by the event filtering and routing module 120 of FIG. 1, in some implementations, carries out one or more actions corresponding to the matching rule(s). For example, as illustrated, the event routing feature 222 forwards the mapped event data 202′ to an event handling feature 224 of the customer system 210 as well as to an internal event handling feature 226 of the event processing system 206.

In some implementations, event data may be supplied by the event processing system 206 (e.g., via functionality such as the event routing feature 222) to an external handling system provided by a third party partner. The customer system 210, for example, may be a health plan system, health facility system, government agency system, employer system, or other partner system configured to receive mapped event data 202′ and handle the event internally. The event handling feature 224, for example, may match information items within the event data 202′ (e.g., patient data, laboratory order data, imaging order data, etc.) to internal system data (e.g., patient records, order records, etc.).

In the example illustrated by the flow diagram 200 of FIG. 2, the event handling feature 224 correlates the event data 202′ to patient data 228 and provides the patient data 228 to the emergency room intake system 204. The enhanced event data 202′ provided by the event processing system 206 may include an indication of the source of the event data 202 (e.g., the emergency room intake system 204). Additionally, in some implementations, the event routing feature 222 includes communication information identifying how the customer system 210 can communicate information directly to the emergency room intake system 204.

Upon receipt of the patient data 228 by the emergency room intake system 204, the emergency room intake system 204 renders at least a portion of the patient data 228 to the graphical user interface 208, providing an enhanced user interface 208′. The enhanced user interface 208′, for example, renders patient data 228 information items including allergy information (“none”), medication information (“statin QRX” and “beta blocker MNO”), and surgery information (“coronary bypass Mar. 5, 2002”). The patient data 228, for example, can aid a medical professional reviewing the enhanced user interface 208′ in diagnosis and management of the medical issue that caused patient Jane B. Doe to check into the emergency room intake system 204.

Although the patient data 228 is illustrated as being supplied directly to the emergency room intake system 204 by the customer system 210, in other implementations (not illustrated), the event handling feature 224 of the customer system 210 may respond to the event processing system 206 with the patient data 228, and the event processing system 206 may supply the patient data 228 to the emergency room intake system 204. In this circumstance, the customer system 210 need not be aware of how to communicate directly with the emergency room intake system 204. The patient data 228, rather than being included in a response, in some implementations is handled as a new medical event by the event processing system 206 upon injection by the customer system 210. For example, a customized medical event type established by the customer system 210 may correspond to a supply notification indicating to the event processing system 206 to supply the patient data 228 to the emergency room intake system 204.

Returning to the event routing feature 222 of the event processing system 206, in some implementations, upon supplying the enhanced event data 202′ to the event handling feature 226 of the event processing system 206, the event handling feature 226 generates alert data 230 regarding the event data 202′. Alert data, for example, may include a voice, image, and/or text message (e.g., text formatted, HyperText Markup Language (HTML) formatted, IVR formatted, Portable Document Format (PDF) formatted, etc.) presenting alert information for review by a medical professional. The alert data 230, for example, may present, in natural language format, a synopsis of information related to the event data 202, such as “patient Jane B. Doe is being admitted into the emergency room at City Hospital at 2:18 p.m. on Tuesday, February 7”.

In some implementations, the event handling feature provides the alert data 230 to an alert handling feature 232 of the clinician system 212. The clinician system 212, for example, may include a private practice, health management system, primary care practice, or other third party system configured to receive (if not to supply) medical event related information from the event processing system 206. The alert handling feature 232, in some implementations, is included within a customer portal or other software application supplied by the event processing system 206 for receiving and handling alert data from the event processing system 206. The alert handling feature 232 issues an alert 230′ for review by a medical professional 234.

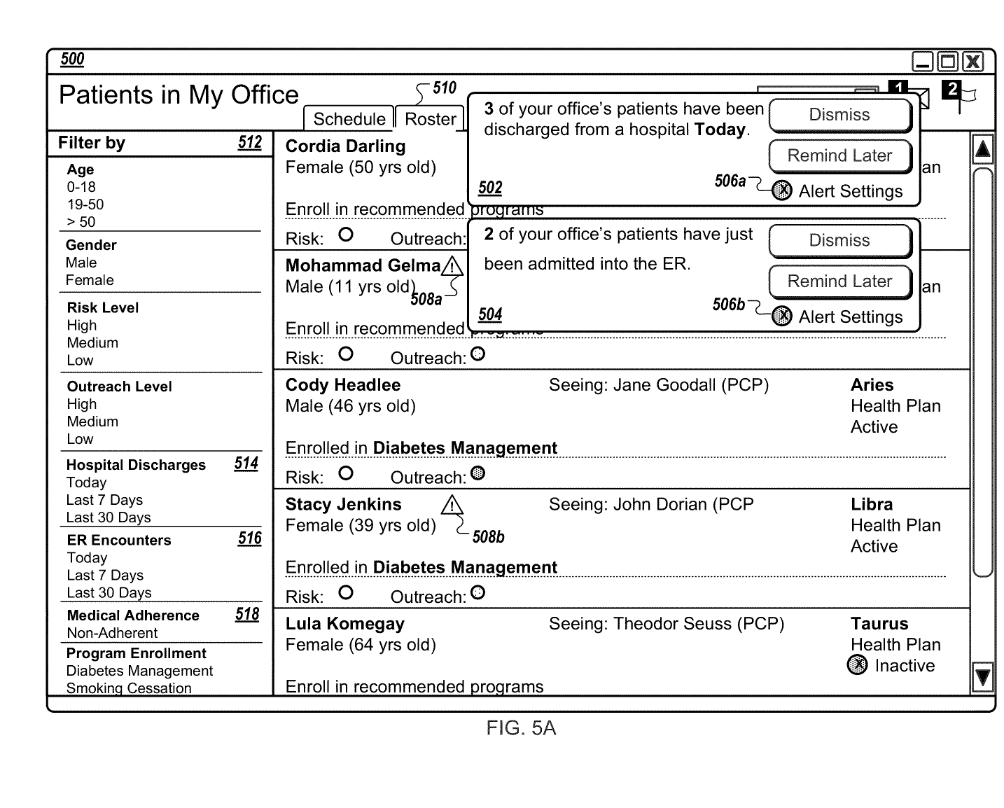

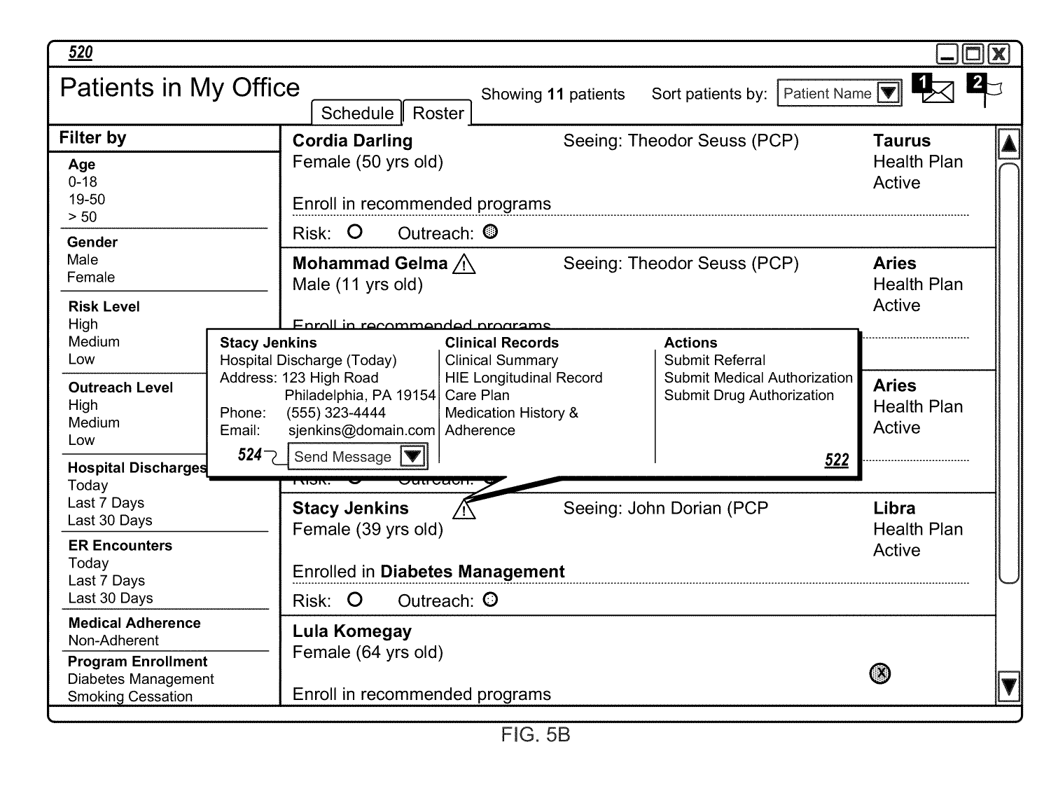

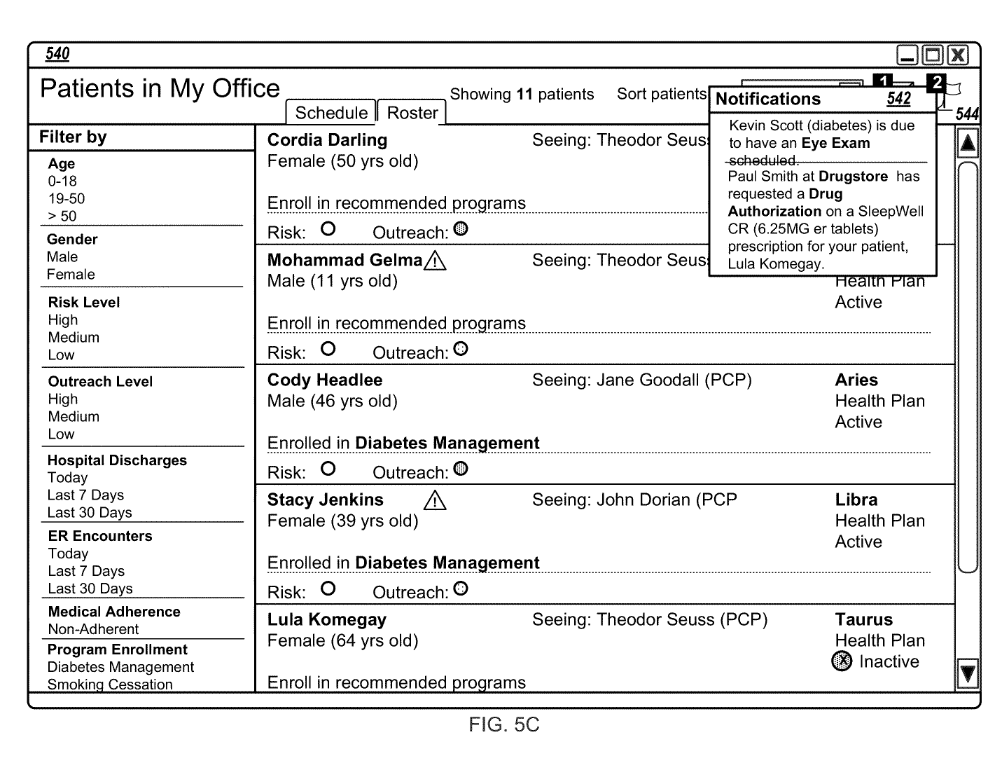

Turning to FIG. 5A, for example, a screen shot 500 illustrates a graphical user interface including identification of a number of alerts associated with patients within a clinician office system. In a first alert notification pane 502, for example, a reviewing medical professional is notified that “3 of your office's patients have been discharged from the hospital Today”. In another example, in a second alert notification pane 504, a reviewing medical professional is notified that “2 of your office's patients have just been admitted into the ER” (e.g., such as Jane B. Doe as identified in relation to FIG. 2). In some implementations, upon selection of one of the alert notification panes 502, 504, the medical professional may be presented with additional information associated with the alert (e.g., such as is supplied within the alert data 230 of FIG. 2).

Returning to FIG. 2, in other implementations (not illustrated), the event handling feature 226 of the event processing system 206 provides the alert data 230 directly to the medical professional 234. For example, based upon a telephone number, mobile application identifier, email address, or other communication channel configured by the clinician system 212 with the event processing system 206, the event processing system 206 may be configured to communicate alert data 230 directly with one or more medical professionals identified as being care providers (e.g., primary care physician, specialist, etc.) of the patient Jane B. Doe.

In some implementations, the clinician system 212 has the ability to configure the alert handling mechanism supplied by one or both of the alert handling feature 232 of the clinician system 212 and the event handling feature 226 of the event processing system 206. For example, as illustrated in FIG. 5A, an alert settings control 506a, 506b, upon selection, may provide the reviewing medical professional with the ability to customize the alert mechanisms associated with hospital discharges and emergency room admissions, respectively. In this manner, an administrator of the clinician system 212 or other user may select options for receiving alert data 230 via the clinician system alert handling feature 232, communication channels associated with various medical professionals, or both.

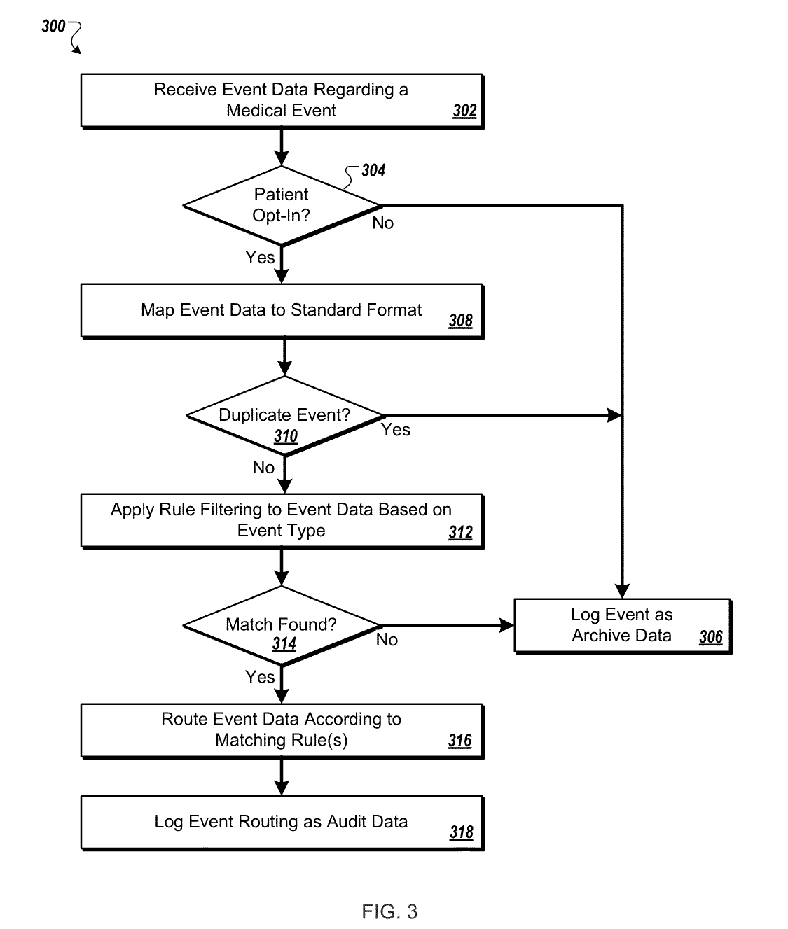

The flow diagram 200 of FIG. 2 illustrates a particular example for event handling. In a more general sense, turning to FIG. 3, a flow chart illustrates an example method 300 for handling incoming medical events. The method 300, for example, may be performed by the centralized processing system 102 described in relation to FIG. 1 or the event processing system 206 described in relation to FIG. 2.

In some implementations, the method 300 begins with receiving event data regarding a medical event (302). The medical event may include an eligibility of medical benefits request (E&B), admission discharge transfer message (ADT), imaging exchange message, or medical billing system exchange message. In some implementations, the medical event is received via a network from a third party system, such as, in some examples, a health facility (e.g., hospital, clinician office, imaging office, dental office, optometrist office, alternative medicine provider office, or other system emitting admission discharge transfer communications), a biometric or consumer/personal medical device (e.g., devices implanted in, worn by, or otherwise used by a patient such as an artificial cardiac pacemaker, medical scale, or automated insulin pump), a health plan system (e.g., health insurance provider, dental insurance provider, vision insurance provider, care management provider, etc.), a health information exchange (HIE), a customer relationship management system (CRM), or a care management system. In further examples, the medical event may be received from a medical referrals system, an authorization system, a utilization management system, a laboratory exchange, an imaging exchange or drop box, a customer relationship management system, a medical billing system, a wellness-related facility or program (e.g., fitness club, weight loss organization, yoga center, martial arts training facility, swim club, tennis/racquet ball club, golf club, etc.), or a travel-related system (e.g., travel insurance program, etc.).

In some implementations, a determination is made whether the patient associated with the medical event has not opted in (or, conversely, has opted out) of personalized medical event processing (304). The determination regarding patient opt-in, in some examples, may be based upon agreement information between the patient and the medical event processing system, an agreement between the patient and a third party system (e.g., such as one of the systems listed above), and/or an agreement made between the medical event processing system and one of the third party systems of which the patient is a member (e.g., a health insurance plan, etc.). In some implementations, in addition to or in lieu of opt-in processing, a determination may be made as to what level of processing a patient has agreed upon. For example, certain types of medical events, such as drug tests and other private or sensitive medical events, may be ineligible for processing based upon user (or third party) agreement. The determination may be made, for example, by the opt-out handling module 123 of the central processing system 102 (described in relation to FIG. 1) or the opt-in/out filter feature 214 of the event processing system 206 (described in relation to FIG. 2).

If it is determined that the patient associated with the medical event has not opted-in (or has opted-out) of personalized medical event processing (304), in some implementations, the medical event is logged as archive data (306). For example, the medical event information may be made anonymous to protect the privacy settings of the patient, and the medical event information may be archived to storage for statistical and/or research purposes. The archive management module 118 (described in relation to FIG. 1), for example, may archive the medical event data. The archive data, in some examples, may be stored in a secure storage medium and/or stored in a secure (e.g., encrypted, etc.) format.

If, instead, the patient has opted into the personalized medical event processing system (304), in some implementations, the medical event data is mapped to a standard format (308). For example, an event type of the medical event may be mapped to a standard event category, and/or the formatting of the medical event information may be mapped to a standard canonical data format. The event mapping module 121 (described in relation to FIG. 1), for example, may map the medical event data. In another example, the event mapping feature 216 (described in relation to FIG. 2) may be used to map the medical event information.

In some implementations, it is determined whether the medical event is a duplicate (310). Processing of medical events can lead to a number of individual medical event communications related to a single circumstance. For example, an ambulance may register a patient on the way to a hospital, and the hospital may register the patient upon admission.

Both of these registrations could be identified as a single “event”, e.g., fainting in the supermarket and paying a visit to the hospital. In another example, a same medical event may be forwarded from two different third party sources (e.g., both the hospital and a health plan which received the event from the hospital). To reduce the number of alerts and other processing activities related to the event, each event may be processed to avoid identical or substantially similar (e.g., related to the same medical issue) events from generating duplicate activity.

In some implementations, if the medical event is determined to be a duplicate of a previous medical event (310), the event is logged as archive data (306).

If, instead, the medical event is not determined to be a duplicate (310), in some implementations, rule filtering is applied to the medical event data based on the event type (312). The medical event may be filtered based upon one or more rules depending upon the event type and, optionally, additional information such as one or more third parties associated with the patient (e.g., health care provider, employer, medical study coordinator, etc.). Each rule may designate one or more actions to apply to events satisfying one or more filter criteria. The filter criteria, in some examples, may include event type criteria (e.g., prescription fulfillment, emergency room admission, imaging order availability, etc.), health plan criteria (e.g., members of a particular health plan or a particular service level of a particular health plan, etc.), employer criteria (e.g., employees of a particular entity), a research study criteria (e.g., participant of a particular study), a primary care facility criteria (e.g., patients of a particular office), and/or a critical care facility criteria (e.g., events generated by an ambulance service, hospital emergency room, or other critical care facility). The medical event data may be filtered, for example, by the event filtering and routing module 120 (described in relation to FIG. 1) or the rule filtering feature 218 (described in relation to FIG. 2).

In some implementations, if a match between the medical event and the one or more filters is not found (314), the medical event is logged as archive data (306).

If, instead, a match is found (314), in some implementations, the medical event data is routed according to actions identified by the one or more matching rules (316). The actions, in some implementations, may include the forwarding of information and/or issuance of alert notifications to designated accounts (e.g., network portal accounts third party systems have established with the processing entity) or via designated communication channels. The communication channels, in some examples, may include short message system (SMS) numbers, email addresses, machine-to-machine communication channels, mobile device applications, and/or facsimile numbers. The medical event data may be routed, for example, by the event filtering and routing module 120 (described in relation to FIG. 1) or the event routing feature 222 (described in relation to FIG. 2).

In some implementations, the routing of the medical event is logged as audit data (318). The audit data, for example, may contain a series of records identifying a timestamp, a medical event (e.g., full event data, partial event data, or a link cross-referenced into the archive data archived in step 306), a rule (e.g., rule name, full rule data, or link cross-referenced into a rules data store), and/or a recipient (e.g., communication channel or end user/entity associated with the handling of the event). The audit data may prepared and stored, for example, by the audit management module 126 of FIG. 1.

Although described in relation to a particular series of events, one or more steps of the method 300 may be performed in a different order. For example, in some implementations, even though it is determined that a patient has opted out of processing (304), the medical event data may be mapped to a standard format (308) prior to archival, for example to make the data easier to query for research and/or statistical purposes. Additionally, in some implementations, determinations regarding patient opt-in, duplicate events, and/or non-matching events may be logged as audit data (318) as well as matched events.

In other implementations, steps may be added and/or removed from the method 300. For example, certain event data, in some implementations, may not be archived (306), such as duplicate medical event data and/or anonymous medical event data. Depending upon the sources of the medical events, in some implementations, mapping the medical event data to a standard format (308) may not be necessary. For example, the data may be mapped only if it is not already within a particular canonical format.

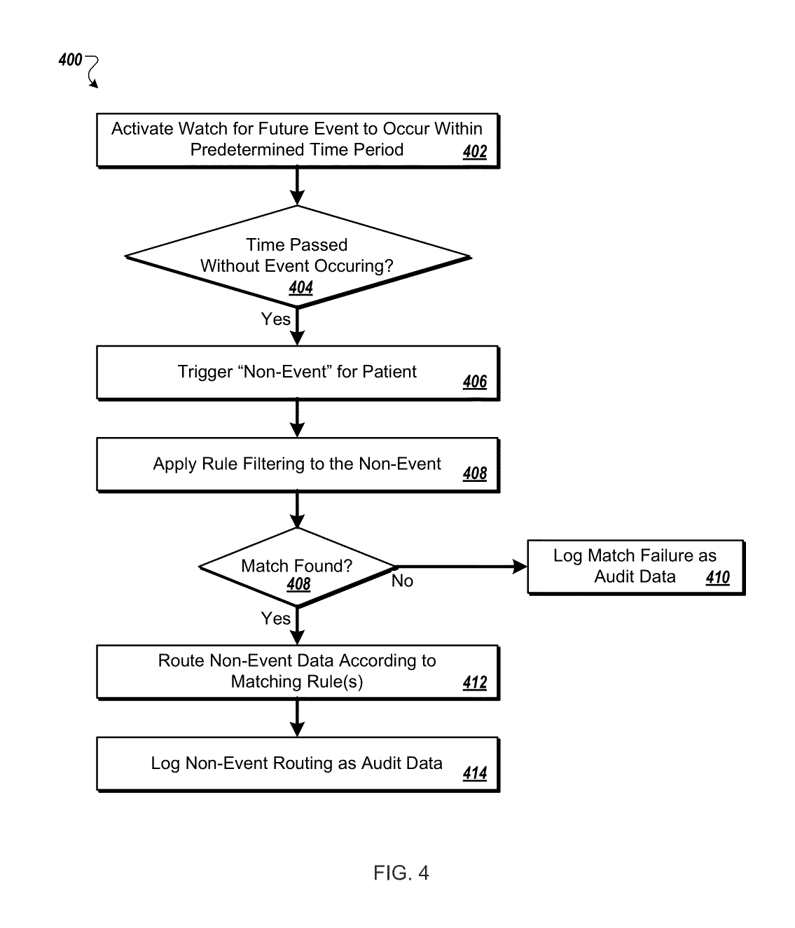

In some implementations, an action corresponding to a matching rule may designate that a watch be placed for an anticipated medical event, occurring within a predetermined time period in the future. Turning to FIG. 4, a flow chart illustrates an example method 400 for handling medical non-events (e.g., the failure of identification of an anticipated medical event within the predetermined period of time). The method 400, for example, may be performed by the centralized processing system 102 described in relation to FIG. 1 or the event processing system 206 described in relation to FIG. 2.

In some implementations, the method 400 begins with activating a watch for a future event to occur within a predetermined time period (402). The watch, for example, may be triggered by an action designated by a rule, as described in relation to step 316 of the method 300 of FIG. 3. The event triggering module 128, for example, may activate the watch for the future event. In a particular example, upon identification of a final refill of a type of prescription medication corresponding to periodic doctor visits, a watch for a doctor visit within the dosage cycle (e.g., two weeks, thirty days, etc.) of the prescription medication may be activated.

In some implementations, it is identified that the predetermined period of time has passed without occurrence of the anticipated future event (404). The future event watch, in some examples, may be accomplished through an internal custom rule (e.g., a rule designed to match a particular type of event and a particular patient) or through periodically querying archived event data for a match with the anticipated future event.

In some implementations, a “non-event” is triggered corresponding to the patient and the anticipated event (406). Following the example above, upon failure to identify a visit of the patient to the clinician's office within the predetermined time frame, an internal medical event (e.g., “missed event” or “non-event”) may be triggered. The non-event, for example, may include medical event information similar in structure to a medical event that is received from a third party. The non-event may be designated as an internal non-event (e.g., for processing purposes).

In some implementations, rule filtering is applied to the non-event (408). As discussed above in relation to step 312 of the method 300 (described in relation to FIG. 1), the non-event may be filtered based upon one or more rules depending upon the event type and, optionally, additional information such as one or more third parties associated with the patient (e.g., health care provider, employer, medical study coordinator, etc.). Each rule may designate one or more actions to apply to events satisfying one or more filter criteria. The filter criteria, in some examples, may include event type criteria (e.g., prescription fulfillment, emergency room admission, imaging order availability, etc.), health plan criteria (e.g., members of a particular health plan or a particular service level of a particular health plan, etc.), employer criteria (e.g., employees of a particular entity), a research study criteria (e.g., participant of a particular study), a primary care facility criteria (e.g., patients of a particular office), and/or a critical care facility criteria (e.g., events generated by an ambulance service, hospital emergency room, or other critical care facility). The medical event data may be filtered, for example, by the event filtering and routing module 120 (described in relation to FIG. 1) or the rule filtering feature 218 (described in relation to FIG. 2). In some implementations, rules designated as “non-event” rules are applied to the non-event. For example, specific rules may be invoked upon identifying that an action failed to occur within a prescribed period of time. In other implementations, any matching rule in the system may be applied to the non-event.

If a matching rule to the non-event is not found (408), in some implementations, the failure to match the non-event to an existing rule is logged as audit data (410). For example, the system may track, for statistical and corrective purposes, circumstances in which non-events fail to result in an action.

If, instead, a match is found (408), in some implementations, the non-event data is routed according to the matching rule(s) (412). As described above in relation to step 316 of FIG. 3, the action(s) associated with the matching rule(s), may include the forwarding of information and/or issuance of alert notifications to designated accounts (e.g., network portal accounts third party systems have established with the processing entity) or via designated communication channels. The communication channels, in some examples, may include short message system (SMS) numbers, email addresses, machine-to-machine communication channels, mobile device applications, and/or facsimile numbers. Further to the example described above in relation to the expired prescription, an action designated by a matching rule may result in issuance of an alert to the clinician to follow up with the patient. The medical event data may be routed, for example, by the event filtering and routing module 120 (described in relation to FIG. 1) or the event routing feature 222 (described in relation to FIG. 2).

In some implementations, the routing of the non-event is logged as audit data (414). As described above in relation to step 318 of the method 300 of FIG. 3, for example, the audit data may contain a series of records identifying a timestamp, a medical event (e.g., full event data, partial event data, or a link cross-referenced into the archive data archived in step 306), a rule (e.g., rule name, full rule data, or link cross-referenced into a rules data store), and/or a recipient (e.g., communication channel or end user/entity associated with the handling of the event). The audit data may be prepared and stored, for example, by the audit management module 126 of FIG. 1.

Although described in relation to a particular series of events, one or more steps of the method 400 may be performed in a different order, and/or one or more steps may be removed or added to the method 400. For example, in some implementations, rather than or in addition to logging the failure of matching the non-event to at least one rule (410), the method 300 issues an alert to an administrator of the medical event processing system or other interested individual (e.g., third party administrator who manages rules on behalf of the third party, etc.) regarding the failure. The interested individual, for example, may be presented the non-event information and provided the opportunity to remedy the failure (e.g., to hand-forward information related to the non-event to one or more interested parties or to establish rule criteria appropriate to the non-event).

Based upon the rule matching outcome of the method 300 of FIG. 3 and/or the method 400 of FIG. 4, alerts, notifications, and other information may be passed along to third party systems. FIGS. 5A through 5C are screen shots of example user interfaces for receiving information routed according to actions associated with rules identified as medical event matches during medical event processing. The screen shots, for example, may illustrate a software application installed within a third party system or a web portal or other remote application presented to a member of the third party system by the event processing system (e.g., the centralized processing system 102 of FIG. 1 and/or the event processing system 206 of FIG. 2).

Turning to FIG. 5A, the screen shot 500 illustrates a graphical user interface including identification of a number of alerts associated with patients within a clinician office system. As described above, in the first alert notification pane 502 (e.g., pop-up style window), a reviewing medical professional is notified that “3 of your office's patients have been discharged from the hospital Today”. In the second alert notification pane 504, a reviewing medical professional is notified that “2 of your office's patients have just been admitted into the ER” (e.g., such as Jane B. Doe as identified in relation to FIG. 2). In some implementations, upon selection of one of the alert notification panes 502, 504 (e.g., such as the “3” in notification pane 502 or the “2” in notification pane 504), the medical professional is presented with additional information associated with the alert (e.g., such as is supplied within the alert data 230 of FIG. 2). The notification panes 502, 504, for example, may be presented upon logging into the application illustrated within the screen shot 500.

Additionally, the listing of the patients illustrated within a patient roster tab 510 of the screen shot 500 may be filtered by a variety of filtering criteria 512, such as age, gender, risk level, outreach level, and program enrollment. The filtering criteria 512 include categories which may be derived from notifications delivered by a medical event processing system, such as hospital discharges 514, ER encounters 516, and medical adherence 518. For example, to determine medical adherence, the medical event processing system may monitor for fulfillment of prescribed medications and, upon failing to identify the anticipated future event of prescription fulfillment within a predetermined period of time (e.g., within a week of the clinician prescribing the medication), a non-event may trigger a notification to the clinician office application illustrated in screen shot 500, alerting the clinic to the patient's non-adherence to prescribed medications.

In certain circumstances, alert icons 508a, 508b presented in respective patient synopsis data of the patient roster tab 510 are used to alert the user to pending information (e.g., alert, notification, etc.) regarding a medical event associated with the patient. Upon selection of one of the alert icons, icon 508b associated with patient Stacy Jenkins, for example, the user may be presented with a notification dialogue 522, as illustrated in a screen shot 520 of FIG. 5B.

Turning to FIG. 5B, information with the notification dialogue 522 identifies the medical event is related to a “Hospital Discharge (Today)” as well as identifying information related to the patient Stacy Jenkins, including an address, telephone number, email address, controls linking to clinical records, and controls linking to actions (e.g., submit referral, submit medical authorization, and submit drug authorization). A drop-down menu 524 within the notification dialogue 522, when activated, allows the user to select a method for issuing a message to Stacy Jenkins (e.g., email address, IVR message, SMS message, notification within a patient health portal, etc.).

In another example of notification presentation, turning to a screen shot 540 of FIG. 5C, a notification pane 542 presents a series of two notification message regarding two separate patients (e.g., corresponding to a “2” emblem upon a notification icon 544). The notification pane 542 may be presented to the user, for example, upon selection of the notification icon 544 (e.g., mouse click, mouse-over, touch screen selection, etc.).

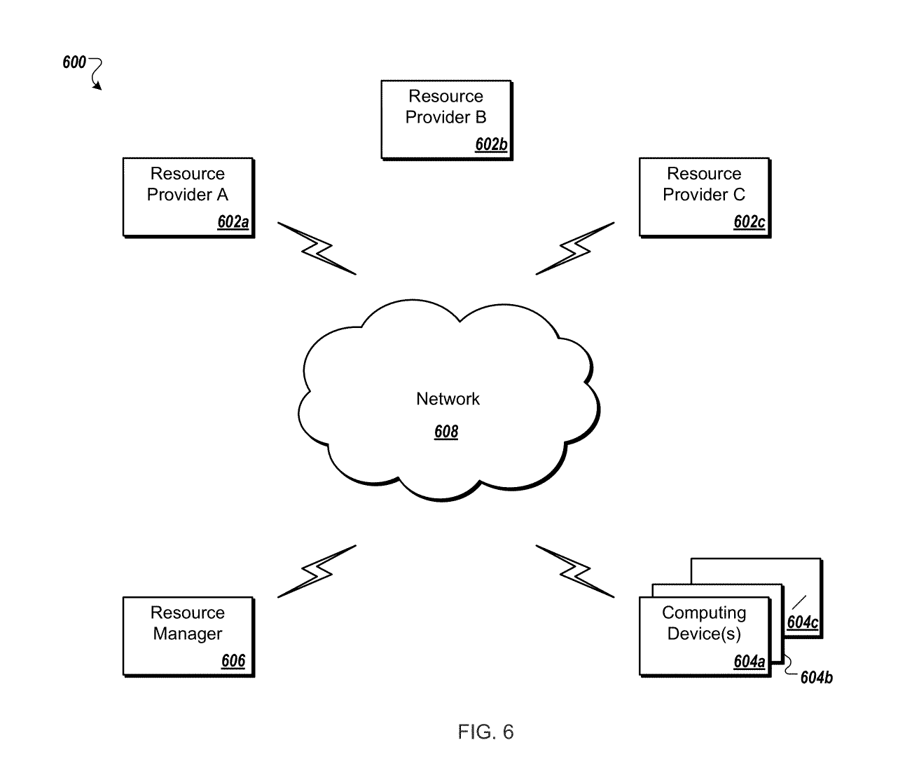

As shown in FIG. 6, an implementation of an exemplary cloud computing environment 600 for identification and processing of medical events is provided. The cloud computing environment 600 may include one or more resource providers 602a, 602b, 602c (collectively, 602). Each resource provider 602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 602 may be connected to any other resource provider 602 in the cloud computing environment 600. In some implementations, the resource providers 602 may be connected over a computer network 608. Each resource provider 602 may be connected to one or more computing device 604a, 604b, 604c (collectively, 604), over the computer network 608.

The cloud computing environment 600 may include a resource manager 606. The resource manager 606 may be connected to the resource providers 602 and the computing devices 604 over the computer network 608. In some implementations, the resource manager 606 may facilitate the provision of computing resources by one or more resource providers 602 to one or more computing devices 604. The resource manager 606 may receive a request for a computing resource from a particular computing device 604. The resource manager 606 may identify one or more resource providers 602 capable of providing the computing resource requested by the computing device 604. The resource manager 606 may select a resource provider 602 to provide the computing resource. The resource manager 606 may facilitate a connection between the resource provider 602 and a particular computing device 604. In some implementations, the resource manager 606 may establish a connection between a particular resource provider 602 and a particular computing device 604. In some implementations, the resource manager 606 may redirect a particular computing device 604 to a particular resource provider 602 with the requested computing resource.

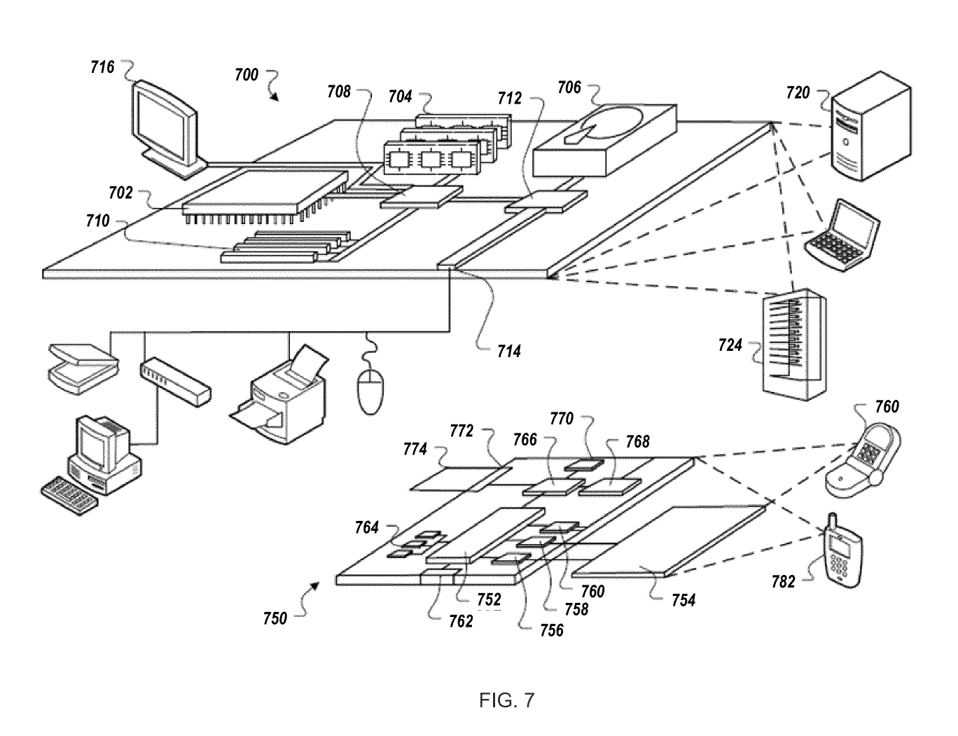

FIG. 7 shows an example of a computing device 700 and a mobile computing device 750 that can be used to implement the techniques described in this disclosure. The computing device 700 is intended to represent various forms of digital computers, such as laptops, desktops, workstations, personal digital assistants, servers, blade servers, mainframes, and other appropriate computers. The mobile computing device 750 is intended to represent various forms of mobile devices, such as personal digital assistants, cellular telephones, smart-phones, tablet computers, and other similar computing devices. The components shown here, their connections and relationships, and their functions, are meant to be examples only, and are not meant to be limiting.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 702), perform one or more methods, such as those described above. The instructions can also be stored by one or more storage devices such as computer- or machine-readable mediums (for example, the memory 704, the storage device 706, or memory on the processor 702).

The high-speed interface 708 manages bandwidth-intensive operations for the computing device 700, while the low-speed interface 712 manages lower bandwidth-intensive operations. Such allocation of functions is an example only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 752), perform one or more methods, such as those described above. The instructions can also be stored by one or more storage devices, such as one or more computer- or machine-readable mediums (for example, the memory 764, the expansion memory 774, or memory on the processor 752). In some implementations, the instructions can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth®, Wi-Fi™, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for identification and processing of medical events are provided. Having described certain implementations of methods and apparatus for supporting identification and processing of medical events, it will now become apparent to one of skill in the art that other implementations incorporating the concepts of the disclosure may be used. Therefore, the disclosure should not be limited to certain implementations, but rather should be limited only by the spirit and scope of the following claims.

What is claimed:

1. A method comprising:
receiving, from an external computing device, via a network, event data regarding a medical event, wherein
the medical event is associated with a patient, and
the event data is received within a time period corresponding to substantially real time in relation to occurrence of the medical event;
mapping, by a processor of a computing device, the event data to a particular event type of a plurality of event types;
applying, by the processor, one or more filters to the event data based at least in part upon the particular event type to determine at least a first matching filter of the one or more filters, wherein each filter of the one or more filters corresponds to a respective handling activity;
routing, by the processor, at least a portion of the event data according to the handling activity of the first matching filter; and
archiving, by the processor, audit data corresponding to the handling activity.

2. The method of claim 1, comprising, prior to mapping the event data to the particular type, determining whether the patient associated with the medical event has agreed to participation.

3. The method of claim 2, wherein applying the one or more filters comprises applying, based upon the patient having not agreed to participation, one or more filters configured to capture information regarding anonymous medical events.

4. The method of claim 1, comprising, prior to applying the one or more filters, determining, by the processor, no duplicate event exists for the medical event.

5. The method of claim 4, wherein determining no duplicate event exists comprises determining no prior event of the particular event type occurred in relation to the patient, within a predetermined period of time.

6. The method of claim 1, wherein mapping the event data further comprises reformatting the event data to a standard canonical data format.

7. The method of claim 1, wherein applying the one or more filters comprises determining a third party entity associated with the patient.

8. The method of claim 7, wherein the third party entity comprises at least one of an employer, a health plan provider, a clinical facility, and an integrated delivery system.

9. The method of claim 1, wherein receiving the event data comprises receiving, from a third party computing system, a request for verification of eligibility of medical benefits.

10. The method of claim 1, wherein the external computing device comprises a biometric device of the patient.

11. The method of claim 1, wherein the time period comprises twenty-four hours.

12. The method of claim 1, wherein the event type comprises one or more of emergency room registration and emergency care facility registration.

13. The method of claim 12, wherein the handling activity comprises issuing an alert to at least one of a medical facility and a clinician associated with the patient.

14. A system comprising:
a processor; and
a memory having instructions stored thereon, wherein the instructions, when executed by the processor, cause the processor to:
receive event data regarding a medical event, wherein the medical event is associated with a patient;
determine a follow-on event corresponding to the medical event, wherein the follow-on event is associated with a time period;
after the time period has expired, determine no historic medical events associated with the patient match the follow-on event;
trigger a non-event, wherein the non-event relates to evident failure of the patient to perform an activity corresponding to the follow-on event within the time period;
apply one or more filters to the non-event based at least in part upon an event type of the follow-on event to determine at least a first matching filter of the one or more filters, wherein each filter of the one or more filters corresponds to a respective handling activity; and
route data corresponding to the non-event according to the handling activity of the first matching filter.

15. The system of claim 14, wherein the follow-on event comprises a medical facility visit and the handling activity comprises issuing an alert to the medical facility.

16. The system of claim 14, wherein the event data is imported from one of a health information exchange, a customer relationship management system, and a care management system.

17. The system of claim 14 wherein the instructions cause the processor to, after routing the data, archive audit data corresponding to the handling activity.

18. A non-transitory computer readable medium having instructions stored thereon, wherein the instructions, when executed by a processor, cause the processor to:
receive, from an external computing device, via a network, event data regarding a medical event, wherein
the medical event is associated with a patient, and
the event data is received within a time period corresponding to substantially real time in relation to occurrence of the medical event;
apply one or more filters to the event data based at least in part upon a particular event type of the medical event to determine at least a first matching filter of the one or more filters, wherein each filter of the one or more filters corresponds to a respective handling activity;
perform the handling activity of the first matching filter, wherein performing the handling activity comprises providing information regarding at least one of the medical event and the patient to a third party computing system within a second time period corresponding to substantially real time in relation to the occurrence of the medical event; and
archive audit data corresponding to the handling activity.

19. The computer readable medium of claim 18, wherein the third party computing system comprises the external computing device.

20. The computer readable medium of claim 18, wherein the second time period comprises less than five minutes.
